(19) United States
(12) Patent Application Publication
(10) Pub. No.: US 2007/0258586 A1
(43) Pub. Date: Nov. 8, 2007

(54) PERSONAL VIDEO RECORDER HAVING DYNAMIC SECURITY FUNCTIONS AND METHOD THEREOF

(76) Inventors: Chien-Chung Huang, San Jose, CA (US); Freimann Felix, Sunnyvale, CA (US); Yuan-Liang Cheng, San Jose, CA (US); Tung-Hao Huang, Tai-Chung City (TW)

Correspondence Address: NORTH AMERICA INTELLECTUAL PROPERTY CORPORATION, P.O. BOX 506, MERRIFIELD, VA, 22116, US

(21) Appl. No.: 11/380,663

(22) Filed: Apr. 28, 2006

(51) Int. Cl. H04N 7/167

(52) U.S. Cl. 380/201

(57) ABSTRACT

A method of processing a transport stream having a plurality of packets to output a protected transport stream includes providing a set of secret keys having a predetermined number of secret keys; generating a key indication value; selecting a secret key from the set of secret keys according to the key indication value to form a selected secret key; generating an encrypted packet based on the selected secret key and a packet in the transport stream by: encrypting the payload of the packet according to the selected secret key, and storing the key indication value in the sync field; and generating the protected transport stream based on the encrypted packet. Where each packet comprising a packet header and a payload, the packet header comprising a sync field, and the sync field carrying a preset sync pattern.

### BACKGROUND OF INVENTION

1. Field of the Invention

The invention relates to personal video recorders, and more particularly, to a personal video recorder having dynamic security functions for improved content protection.

2. Description of the Prior Art

A personal video recorder (PVR) is a generic term referring to a device that is similar to a video cassette recorder (VCR) but records television data utilizing a digital format as opposed to an analog format such as used by a VCR. A PVR can also be referred to as a hard disk recorder (HDR), a digital video recorder (DVR), a personal video station (PVS), or a personal TV receiver (PTR). While VCRs utilize analog tapes to record and play programs broadcast over television, PVRs encode video data in digital formats such as Moving Pictures Expert Group (MPEG) MPEG-1 or MPEG-2 and store the data in a digital storage device such as a hard drive. PVRs need to provide similar functionality as VCRs (recording, playback, fast forwarding, rewinding, and pausing) and also include the ability to instantly jump to any part of a television program without having to rewind or fast forward the data stream. A benefit of the PVR system is that these functions can also be applied to a television program that is currently being received. That is, from the respect of a user, the functions of the PVR are still available even when she/he is watching a live television broadcast.

A PVR is essentially made up of two portions: (1) a device that accommodates its hardware elements such as the hard disk drive, power supply and buses, and (2) software that may access a subscription service for providing program information and provides the ability to encode and decode data streams. Additionally, when implemented as a set-top box, the PVR receives a transport stream as an input signal. In this situation, because the transport stream has crossed a network of some kind, there may be errors in the input signal. Furthermore, packets of the input signal received from the transport stream may arrive in any order and may be reduced in size due to the properties of the network. For example, the packet size defined in the wireless networks, cable based networks, optical networks, and asynchronous transfer mode (ATM) networks are different from each other.

Transport (de)Packetization and (de)Multiplexing refers to the means of dividing each bit stream into “packets” of information, the means of uniquely identifying each packet or packet type, and the appropriate methods of interleaving or multiplexing video bit stream packets, audio bit stream packets, and data bit stream packets into a single transport mechanism. The structure and relationships of these bit streams is carried in service information bit streams, also multiplexed in the single transport mechanism. In developing the transport mechanism, interoperability among digital media—such as terrestrial broadcasting, cable distribution, satellite distribution, recording media, and computer interfaces—was a prime consideration. The digital television (DTV) system employs the MPEG-2 Transport Stream syntax for the packetization and multiplexing of video, audio, and data signals for digital broadcasting systems. The MPEG-2 Transport Stream syntax was developed for applications where channel bandwidth or recording media capacity is limited and the requirement for an efficient transport mechanism is paramount.

FIG. 1 illustrates a diagram showing multiplexing and de-multiplexing operations between a transmitter 102 and a receiver 104 according to the related art. In this example, the de-multiplexing operations of the receiver 104 are implemented within a PVR system. As shown in FIG. 1, a plurality of extra information (Information Payload, Control PSI/PSIP and Clock Control PCR) added to the transport stream 106 before being modulated for RF transmission. Alternatively, in other implementations, the transport stream 106 is sent via a network (not shown) and is received by the receiver 104 as the transport stream 108. In both situations, de-multiplexing operations of the receiver 104 extract the original information and control information (PSI/PSIP) while reducing jitter.

In general, the transport streams 106, 108 aim for trans-network data delivery. In order to allow proper interconnectivity and network transportation, data information is segmented into 188 byte packets with Transport Header and Adaptation on top of a Packetized Elementary Stream (PES), Program Specific Information (PSI) or Program Information (SI) using multiplexer 110 (where PSIP is used in ATSC and SI is used in DVB). Please note that the PES packet is the unit structure of transforming an elementary stream and is defined by the MPEG-2 coding system.

The data stream including television program content is provided by a service provider. In order to protect their content, service providers typically encrypt the data corresponding to the television program for transportation across the network. For example, in order to protect intellectual property of content during transport, condition access (CA) or CableCard is used to provide content security. The basic concept of CA involves using a secret key exchange method between two sides, service provider and users, and then scrambling the content with secret keys.

As mentioned above, service providers have a vested interest in the security of television programming and other content to insure bill-of-service in place. Any illegal copying, viewing, or other uses of the data must be prevented and forbidden. If PVR systems simply store plain text (unencrypted) data within the PVR system, this will make content copy more feasible. Therefore, it is obvious that service providers would prefer to have PVR systems store the content in a more secure and encrypted format. However, storing data in an encrypted format within the PVR system tends to make some of the must have functions such as random access of different time areas of the program difficult. For example, if a user wants to fast forward three minutes, the PVR system cannot directly skip an equivalent to three minutes worth of encrypted data from its storage medium because some of the encrypted data skipped may actually contain packets corresponding to secret key information. That is, the PVR system may be unable to decrypt the data because the PVR system does not know the corresponding key with which the data was originally encrypted. Therefore, a PVR with dynamic security functions need to be improved to provide sufficient content protection while continuing to support must have user functions like random access.

### SUMMARY

One objective of the claimed invention is therefore to provide a method of embedding information in a synchronization byte of a packet stored in a personal video recorder to thereby allow dynamic security functions for improved content protection at the same time enable random access functions.

According to an exemplary embodiment of the claimed invention, a method of processing a transport stream comprising a plurality of packets to output a protected transport stream is disclosed. Each packet comprising a packet header and a payload, the packet header comprising a sync field, the sync field carrying a preset sync pattern. The method comprising (a) providing a set of secret keys having a predetermined number of secret keys; (b) generating a key indication value; (c) selecting a secret key from the set of secret keys according to the key indication value to form a selected secret key; (d) generating an encrypted packet based on the selected secret key and a packet in the transport stream by: encrypting the payload of the packet according to the selected secret key, and storing the key indication value in the sync field; and (e) generating the protected transport stream based on the encrypted packet.

According to another exemplary embodiment of the claimed invention, a method of processing a protected transport stream comprising a plurality of packets to generate a decrypted transport stream is disclosed. Each packet comprising a packet header and a payload, the packet header comprising a sync field. The method comprising (a) providing a set of secret keys having a number of secret keys; (b) identifying a packet of the protected transport stream as an encrypted packet or an unencrypted packet according to the sync field of the packet; (c) extracting a key indication value from the sync field of the encrypted packet in the protected transport stream; (d) selecting a secret key from the set of secret keys according to the extracted key indication value; (e) generating a decrypted packet based on the encrypted packet and the selected secret key, comprising: decrypting the payload of the encrypted packet based on the selected secret key; and (f) outputting the decrypted packet and the unencrypted packet, if available, to form the decrypted transport stream.

According to another exemplary embodiment of the claimed invention, an apparatus is disclosed for processing a transport stream comprising a plurality of packets to output a protected transport stream. Each packet comprising a packet header and a payload, the packet header comprising a sync field, the sync field carrying a preset sync pattern. The apparatus comprising a table storing a set of secret keys having a predetermined number of secret keys; a key selecting module for generating a key indication value and selecting a secret key from the set of secret keys according to the key indication value to form a selected secret key; an encryption module for receiving a packet in the transport stream and generating an encrypted packet by encrypting the payload of the clear packet according to the selected secret key to form the payload of the encrypted packet and storing the key indication value within the sync field of the encrypted packet; wherein each encrypted packet is outputted to form the protected transport stream.

According to another exemplary embodiment of the claimed invention, an apparatus is disclosed for processing a protected transport stream comprising a plurality of packets to output an unprotected transport stream, each packet comprising a packet header and a payload, the packet header comprising a sync field. The apparatus comprising a key table storing a set of secret keys having a number of secret keys; a demux unit for receiving the protected transport stream, identifying a packet of the protected transport stream as an encrypted packet or an unencrypted packet according to the sync field of the packet, outputting the encrypted packet to form an encrypted packet stream and outputting the unencrypted packet, if available, to form an unencrypted packet stream; a key extraction module for outputting a selected secret key by extracting a key indication value from the sync field of an encrypted packet in the encrypted transport stream and using the key indication value to look into the key table to obtain the selected secret key; a decryption module for receiving the encrypted packet, generating a decrypted packet based on the encrypted packet and the selected secret key by at least decrypting the payload of the encrypted packet according to the selected secret key, outputting each decrypted packet to form a decrypted packet stream; and a mux unit for generating the unprotected packet stream by multiplexing the decrypted packet stream and the unencrypted packet stream, if available.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a diagram showing multiplexing and de-multiplexing operations between a transmitter and a receiver according to the related art.

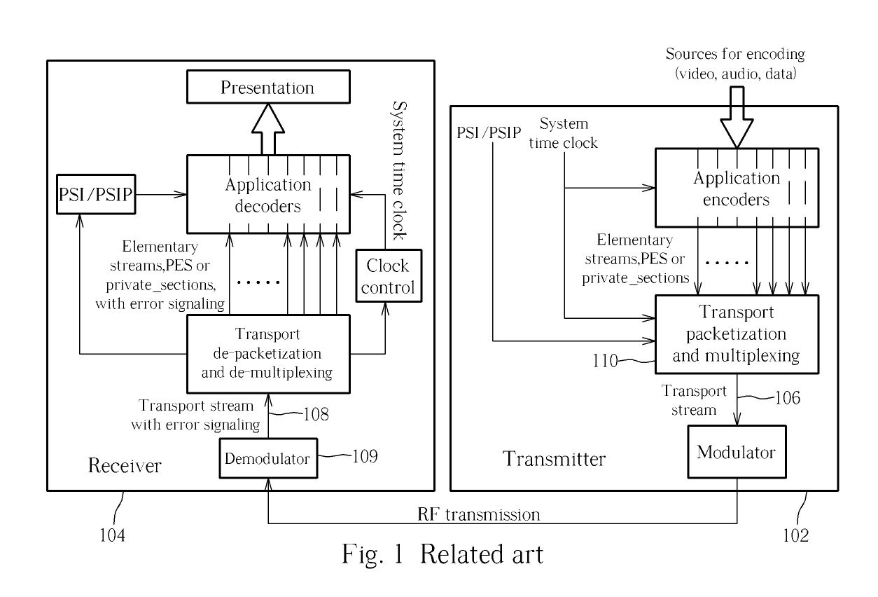

FIG. 2 is a functional diagram of an encryption section in a personal video recorder (PVR) system according to an exemplary embodiment of the present invention.

FIG. 3 is a functional diagram of a decryption section in a personal video recorder (PVR) system according to an exemplary embodiment of the present invention.

FIG. 4 is a diagram describing embedding information in a synchronization byte of a packet stored in the encryption section of FIG. 2 according to an exemplary embodiment of the present invention.

FIG. 5 is a diagram describing extra packet insertion according to another exemplary embodiment of the present invention.

FIG. 6 is a flowchart showing security operations when storing a packet into the storage device of FIG. 2.

FIG. 7 is a table describing the transport packet syntax for the moving picture experts group MPEG-2 standard according to the related art.

### DETAILED DESCRIPTION

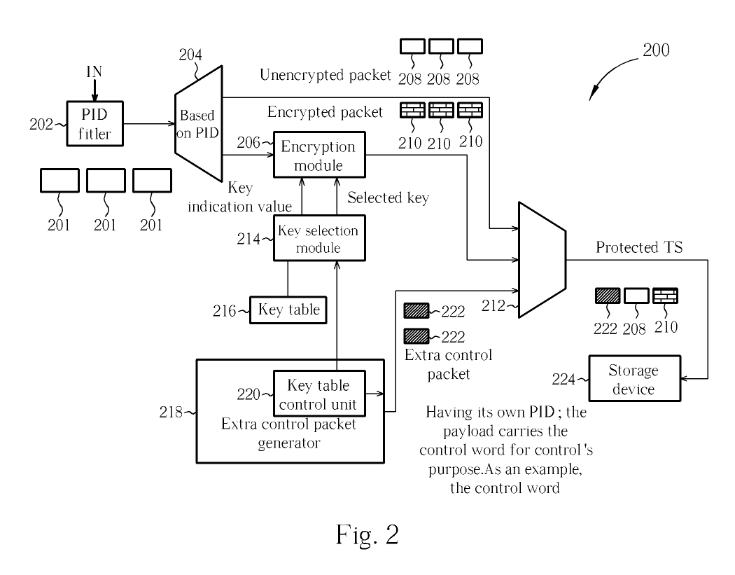

FIG. 2 is a functional diagram of an encryption section 200 in a personal video recorder (PVR) system according to an exemplary embodiment of the present invention. As shown in FIG. 2, the encryption section 200 includes a packet identifier (PID) filter 202, a de-multiplexer 204, an encryption module 206, a key selection module 214, a key table 216, an extra control packet generator 218, a key table control unit 220, a multiplexer 212, and a storage device 224. The encryption section 200 processes an incoming transport stream IN to thereby generate a protected transport stream for storage in the storage device 224. The incoming transport stream IN includes a plurality of packets, of which only a subset of packets are selected for storage by the PVR system. The PID filter 202 makes this selection according to the packet identifier (PID) of each packet. Only transport stream packets 201 having packet identifiers corresponding to content that is to be stored in the PVR system are allowed to pass through the PID filter 202.

The de-multiplexer 204 separates the transport stream packets 201 passed by the PID filter 202 into packets that do not require encryption (unencrypted packets 208) and packets that require encryption, which are passed to the encryption module 206. The separation operation performed by the de-multiplexer 204 is also performed according to the packet identifier of each transport stream packet 201. For example, packets having packet identifiers that correspond to protected content such as feature movies requiring encryption are passed to the encryption module 206. Packets having packet identifiers that correspond to unprotected content (i.e., unencrypted packets 208) such as free programming that do not require encryption are passed directly to multiplexer 212.

Encryption of packets is performed by the encryption module 206 as follows. The key table 216 provides a set of secret keys having a predetermined number of secret keys. For example, in one embodiment, 16 secret keys are included in the key table 216. For each packet that is to be encrypted, the key selection module 214 selects a particular secret key from the key table 216. The actual selection technique can be implemented in a number of ways. For example, a random key from the key table 216 is utilized in one embodiment, or a fixed rotation order is utilized in another embodiment. Other methods of key selection by the key selection module 214 could be implemented and the present invention is not limited to only random or fixed order key selection.

After selecting a particular secret key from the key table 216, the key selection module 214 passes the selected key and also generates and passes a key indication value to the encryption module 206. The key indication value is an indication of which key from the key table 216 was selected for encryption and could be something as simple as an index value from the key table, or something more complicated such as a unique hash value corresponding to the selected secret key. The encryption module 206 generates an encrypted packet 210 by encrypting the payload of the packet to be encrypted utilizing the selected secret key. Additionally, the encryption module 206 stores the key indication value within the synchronization field (hereafter referred to as the sync field) of the encrypted packet 210. In this way, the key indication value referring to the selected secret key is carried within the synchronization field of each encrypted packet 210, and this allows a decryption section (explained in more detail later) to also select the same secret key and decrypt the payload of each encrypted packet 210. Additionally, storing the key indication value within the sync field of each encrypted packet 210 has the added benefit of allowing random access of different areas of data corresponding to a particular content program upon playback. Further explanation of randomly accessing different areas of the content program, and different embodiments explaining how the key indication value is stored within the sync field are discussed later in this description. The encrypted packets 210 generated by the encryption module 206 are passed to the multiplexer 212.

In order to increase the security and allow for an infinite number of possible keys, the key table control unit 220 is utilized to generate new secret keys and to update the set of secret keys in the key table 216 by replacing some (or all) of the secret keys within the key table 216 with new secret keys. Additionally, the extra control packet generator 218 generates at least one extra control packet 222 to carry control information regarding the new secret keys that were generated by the key table control unit 220 and stored in the key table 216. For example, the control information could contain encrypted copies of the new secret keys, seed values for the algorithm that was utilized to create the new secret keys, or could contain other information that would allow the decryption section (explained later) to generate new secret keys for decryption that correspond to the new secret keys that were added to the key table 216 and used for encryption. The extra control packets 222 containing the information regarding the new secret keys in the key table 216 are also passed to the multiplexer 212. The multiplexer 212 multiplexes the unencrypted packets 208, the encrypted packets 210, and the extra control packets 222 into a single protected transport stream, which is then stored within the storage device 224. In this way, any content that has been designated as protected content, such as feature movies etc, is stored in within the storage device 224 of the PVR system in an encrypted form.

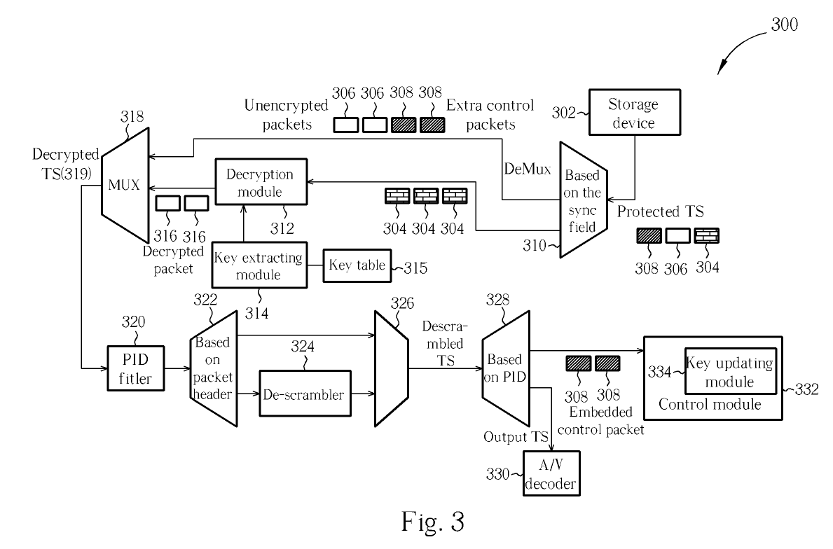

FIG. 3 is a functional diagram of a decryption section 300 in a personal video recorder (PVR) system according to an exemplary embodiment of the present invention. As shown in FIG. 3, the decryption section 300 includes a storage device 302, a first de-multiplexer 310, a decryption module 312, a key extracting module 314, a key table 315, a first multiplexer 318, a PID filter 320, a second de-multiplexer 322, a de-scrambler 324, a second multiplexer 326, third de-multiplexer 328, an audio visual (A/V) decoder 330, a control module 332, and a key updating module 334. The decryption section 300 processes a protected transport stream read from the storage device 302 to thereby produce a decrypted transport stream for playback by the A/V decoder 330. Please note that in the following description it is assumed that the storage device 302 of FIG. 3 corresponds to the storage device 224 of FIG. 2; however, the present invention is not limited to his embodiment as the PVR system could in fact comprises multiple storage devices or allow for removable/swappable storage devices in other embodiments while still following the teachings of the present invention. The protected transport stream read from the storage device 302 includes unencrypted packets 310, extra control packets 308, and encrypted packets 304. The first de-multiplexer 310 separates the encrypted packets 304 for decryption by the decryption module 312. The extra control packets 308 and the unencrypted packets 310 are passed directly to multiplexer 318.

Decryption of the encrypted packets 304 is performed as follows. In order to determine which key from the key table 315 should be utilized to decrypt each encrypted packet 304, the key extracting module 314 examines the sync field of each encrypted packet 304 and selects the appropriate secret key from the key table 315 according to the key indication value stored within the sync field. As previously mentioned, the key indication value indicates which key from the key table 216 in FIG. 2 was utilized for encryption. As will be explained, the secret keys in the key table 315 are made to directly correspond at each moment in time to the same secret keys in the key table 216 of FIG. 2. In this way, for example, an encrypted packet 304 having a key indication value indicating a third secret key in the key table 216 of FIG. 2 was utilized during encryption can be decrypted by utilizing the third secret key in the key table 315 of FIG. 3. How the keys in the key tables 216 and 315 are made to be the same at each moment in time is explained in detail later in this description. The key extracting module passes the selected secret key corresponding to the key indication value in the sync field of a particular encrypted packet 304 to the decryption module 312. The decryption module then decrypts the payload of the particular encrypted packet 304 to thereby generate a decrypted packet 316. This process is then repeated for the next encrypted packet 304. That is, the key indication value in the sync field of each encrypted packet 304 is utilized to select the appropriate secret key from the key table 315 for decryption by the decryption module 312. The decrypted packets 316, the unencrypted packets 306, and the extra control packets 308 are multiplexed into a decrypted transport stream (TS) 319.

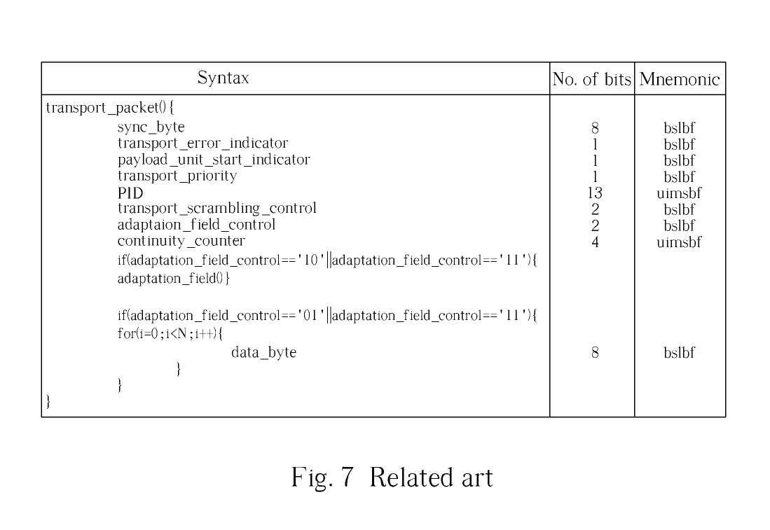

The PID filter 320 is optionally utilized to filter the decrypted transport stream 319 to only allow packets that correspond to content that has been selected for playback by the PVR system and extra control packets 308 to be passed to the following stages for processing. For example, a user of the PVR system may only want to watch a particular content stream, and the PID filter 320 only passes packets having a PID corresponding to the particular content stream to pass to demultiplexer 322, in addition to the extra control packets 308. Demultiplexer then separates the packets that were passed by the PID filter 320 into packets that have been scrambled and packets that have not been scrambled. The demultiplexer performs this separation operation according to the packet header. As was previously mentioned and will be readily understood by a person of ordinary skill in the art, the transport_scrambling_control field within the packet header indicates if the MPEG-2 Transport Stream packet payload has been scrambled. Note that the MPEG-2 Transport Stream packet header, the optional adaptation field, and the payload of a Null MPEG-2 Transport Stream packet are never scrambled. Further information regarding the packet header is described in FIG. 7 and the corresponding description. Packets that have been scrambled are passed to the de-scrambler 324 and packets that have not been scrambled are passed directly to the multiplexer 326. As the de-scrambling operation is already well documented in the related art, further explanation of the de-scrambling operation performed by the de-scrambler 324 is omitted herein for the sake of brevity.

The multiplexer 326 combines the de-scrambled packets outputted by the de-scrambler 324 and the packets received directly from the demultiplexer 322 into a single stream. The demultiplexer 328 then passes the extra control packets 308 to the control module 332, and passes the other packets containing content data to the A/V decoder 330 for playback.

As was previously mentioned, when each encrypted packet 304 is decrypted, the secret keys in the key table 315 of FIG. 3 must correspond to the secret keys in the key table 214 that were utilized during the encryption process. In this way, the key indication value located in the sync field of the each encrypted packet 304 will properly indicate which secret key from the key table 315 should be utilized during the decryption process of the decryption module 312. The extra control packets 308 are utilized by the key updating module 334 for this purpose. More specifically, the extra control packets 308 carry control information regarding new secret keys that were stored in the key table 216 of FIG. 2. The key updating module utilizes this control information to thereby generate corresponding new secret keys for storage in the key table 315 of FIG. 3. For example, in one embodiment, the extra control packets could include encrypted copies of the new secret keys which are only readable (i.e., decryptable) by the key updating module 334. The key updating module then stores updates the key table 315 with these new secret keys. Alternately, in another embodiment, the extra control packets could contain seed values for the algorithm that was utilized to create the new secret keys. In this case, the key updating module would utilize the same algorithm starting from the seed values to thereby generate the new secret keys. Other types of secret keys could also be utilized by the present invention such as public and private secret keys, which will be understood by one of ordinary skill in the art to be a first key utilized for encryption and a corresponding second key that is utilized for decryption. Regardless of the type of secret keys utilized, the key updating module 334 simply needs to use the information contained in the extra control packets to generate new corresponding secret keys for the key table 315. In this way, the key table 315 of FIG. 3 will contain secret keys corresponding to secret keys stored in the key table 216 at the time of the packet's 304 encryption. Therefore, each time a packet 304 is decrypted by the decryption module 312, the key extracting module 314 selects the appropriate secret key from the key table 215 according to the key indication value in the sync field of the encrypted packet 308.

FIG. 7 is a table describing the transport packet syntax from the moving picture experts group MPEG-2 standard according to the related art. In order to explain the detailed operations of the PVR encoding section 200 and decoding section 300 according to the exemplary embodiments shown in FIG. 2 and FIG. 3, respectively, certain fields of the MPEG-2 standard must be examined. As explained in the “Guide to use of ATSC DTV standard”, MPEG-2 TS Packet Structure comprises the first four bytes of the MPEG-2 Transport Stream packet being the Transport Stream packet header. The remaining 184 bytes of an MPEG-2 Transport Stream packet may contain an optional adaptation field and up to 184 bytes of Transport Stream packet payload. If the adaptation field is present, it immediately follows the last byte of the Transport Stream packet header. The adaptation field is not part of the Transport Stream packet header nor the Transport Stream packet payload. When the adaptation field is present, the MPEG-2 Transport Stream packet payload's size is 184 bytes minus the length of the adaptation field. The definition of the contents of an MPEG-2 Transport Stream packet payload may differ depending upon the MPEG-2 stream_type and the encapsulation method.

Concerning the MPEG-2 Transport Stream Packet Syntax, in the packet header, the Packet Identifier (PID) is a 13-bit value used to identify Transport packet from multiplexed packets within the MPEG-2 Transport Stream. Assigning a unique PID value to each bit stream allows Transport Stream packets form up to 8192 (2¹³) separate bit streams to be simultaneously carried within the MPEG-2 Transport Stream. The PID provides a unique bit stream associate to each Transport Stream packet.

The payload_unit_start_indicator is used to signal decoder (by being set to ‘1’) that something “interesting”(start of new PES or PSI) can be found within the payload of the current MPEG-2 Transport Stream Packet. When the payload of the Transport Stream packet contains PES packet data, the payload_unit_start_indicator has the following significance: A ‘1’ indicates that the payload of this Transport Stream packet will commence with the first byte of a PES packet. A ‘0’ the Transport Stream packet payload contains the continuation of a previously started PES along with any necessary stuffing bytes. If the payload_unit_start_indicator is set to ‘1’, it implies that one and only one PES packet starts in this Transport Stream Packet. Two PES packets (or portions thereof) are not permissible in a single Transport Stream packet. This form of signaling, combined with hardware filtering in the decoder, allows for considerable efficiencies in decoding the contents of the stream.

For MPEG-2 sections (PSI and private sections) carried as payload, when the payload_unit_start_indicator field is set to ‘1’, then the first byte of the MPEG-2 Transport Stream packet payload carries the pointer_field, which indicates the byte offset from the start of the Transport Stream packet payload to the beginning of the next PSI or private section. If the payload_unit_start_indicator field is set to ‘0’, then the first byte of the Transport Stream packet payload is not a pointer_field. Instead, the Transport Stream packet payload contains the continuation of a previously started PSI or private section along with any necessary stuffing bytes.

As previously mentioned, the transport_scrambling_control field indicates if the MPEG-2 Transport Stream packet payload has been scrambled. Note that the MPEG-2 Transport Stream packet header, the optional adaptation field, and the payload of a Null MPEG-2 Transport Stream packet (see Section 7.3.2.1) are never scrambled. The adaptation_field_control field signals the inclusion of the optional adaptation field. The most significant bit of the two-bit field always indicates the presence of the adaptation field. The least significant bit indicates the presence of payload.

The continuity_counter field is a 4-bit rolling counter associated with MPEG-2 Transport Stream packets carrying the same PID. The counter is incremented by one for each consecutive Transport Stream packet for a given PID except when the adaptation_field_control field is set to indicate that the Transport Stream packet contains an adaptation field only (no payload) or if it is set to the ‘reserved’ value, or if the Transport Stream packet is a duplicate 7 (these exception cases are known as “non-incrementing conditions”). The continuity_counter is considered “continuous” if it has incremented by one from the continuity_counter value in the previous Transport Stream packet of the same PID or when any of the non-incrementing conditions have been met. The continuity counter is considered “discontinuous” if it has not incremented by one from the continuity counter value in the previous Transport Stream packet having the same PID and nonincrementing condition has not been met. Except in the case when the discontinuity_indicator flag has been set to ‘1’ to signal a discontinuous continuity_counter, if a receiver encounters a situation where the continuity_counter is discontinuous, then it should assume that some number of MPEG-2 Transport Stream packets have been lost.

Two other fields, the transport_error_indicator and the transport_priority, which are not typically used in ATSC transport Streams, are also carried in the packet header. The transport_error_indicator may be used to indicate that at least one uncorrectable bit error exists in the Transport Stream packet. The transport_priority field may be used to indicate that a Transport Stream packet with the field set to ‘1’ is of higher priority than other Transport Stream packets having the same PID which do not have the field set to ‘1’. The payload field carries the data content. The data content can be one of many types; for example, an MPEG-2 PES packet (which itself may contain an elementary stream) or one or more PSI or private sections.

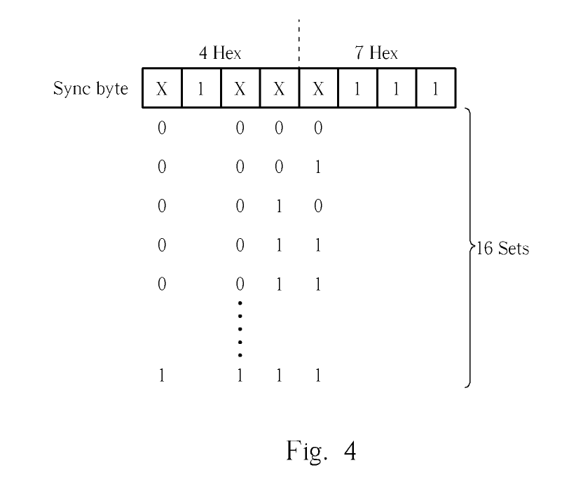

FIG. 4 is a diagram further describing embedding the key indication value within the sync byte of the as performed by the encryption module 206 of FIG. 2 according to an exemplary embodiment of the present invention. As shown in FIG. 4, in one embodiment, the content of the sync byte of the encrypted packet 210 is modified such that the bits corresponding to 47-hexadecimal (8′h47) are set to ones. The record/playback operations of a PVR system only needs to operate correctly on content that has been recorded within the PVR system. That is, a PVR system is a closed system and 188 bytes are well aligned before recording. As long as the PVR system maintains a consistent self record/playback rule, the PVR system can re-define the bits within the sync field with new meanings. The remaining bits of the sync byte that are not set to ones can be used to store specific key information (i.e., the key indication value) based on design requirements. In this way, because no normal sync byte will include the identification information 47-hexadecimal (8′h47), this identification information 47-hexadecimal (8′h47) indicates that the packet 210 includes a key indication value that indicates with which secret key the payload data of the packet is encrypted. For example, using the 47-hexadecimal (8′h47) sync byte definition allows up to sixteen different secret keys to be indicated for each packet, which correspond to the same 16 different secret keys in the key table 216. That is, there are four different bits X remaining in the sync byte that can be used to store a total of sixteen different key indication values. In general, the number of secret keys is equal to the number of bits in the synchronization byte not used by the identification flag raised to the power of two.

In this exemplary embodiment, at any point in time, there are sixteen different secret keys within the key table 214 that are used to encrypt content for storage in the storage device 224. During playback operations, the decryption section 300 is used to retrieve data from the storage device 302. For encrypted packets 304 (i.e., packets having their sync byte modified), decryption is performed by the decryption module 312 according to the secret key indicated by the modified sync byte pattern (i.e., the key indication value stored within the sync field).

As previously mentioned, random access functions such as providing the ability to perform such operations as recording, playback, fast forwarding, rewinding, pausing, and also include the ability to instantly jump to any part of a recorded television or other program content are desirable functions for a PVR system. According to the present invention, random access of different packets is possible because the key extracting module 314 can easily determine which secret key is used for decryption by the decryption module 314. That is, the key extracting module 314 determines which secret key should be used by inspection of the modified sync field of each encrypted packet 304. Additionally, because the sync field (sync_byte) is not a reserved field of the transport packet (transport_packet) shown in FIG. 7, there is no concerns that the function of the data stored in the sync byte will be changed in the future. In other words, because the sync byte has a clearly defined purpose and is only ever used for sync detection outside of the decryption section 300, it is acceptable to modify this field within a PVR system.

In one embodiment, if the keys within the key table 216 and 315 are not changed, by simply indicating which of the secret keys of the key table 214 was utilized to encrypt a packet, if a user wants to fast forward three minutes, the PVR system 200 can directly skip three minutes worth of encrypted data on the storage device 302 and still be able to immediately determine which secret key of the key table 315 needs to be utilized to decrypt data of the encrypted packets 304 retrieved from the storage device 302. Therefore, the PVR system 200 according to this embodiment of the present invention allows for both content protection and random access of the data in the storage device 302.

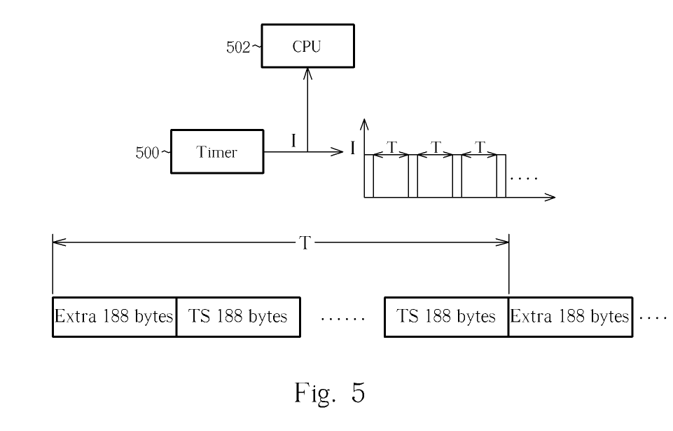

FIG. 5 is a diagram describing extra control packet insertion according to another exemplary embodiment of the present invention. In this embodiment, in order to provide dynamic security functions, the key table control unit 220 of FIG. 2 periodically changes the secret keys that are stored in the key table 216 utilized by the encryption module 206 of FIG. 2. In this situation, as previously mentioned, the key table 315 utilized by the decryption module 312 of FIG. 3 must also be updated with corresponding new secret keys. As shown in FIG. 5, extra control packets are generated according to a timer 500 that is utilized to trigger every predetermined time period T and record a packet number of the extra control packet that is reported to a CPU 502 or control logic within the PVR system. That is, the actual extra control packets 222 are inserted into the protected TS stream according to a timer 500, which is setup by the CPU 502 or the other control logic. The CPU 502 or control logic creates a file meta-data database according to the time vs. packet number information of each extra control packet. As mentioned, the extra control packets 222 are then inserted into the transport stream that is stored within the storage device 224 and comprise information corresponding to the new set of security keys that were stored in the key table 216. While randomly accessing data (either a skip forward or a skip backward function) the decryption module only needs to examine/check the meta-data database to determine a closest location to the desired start of playback. In contrast to the related art, this method of providing a new secret key every time period T is much faster than having to examine every packet in the storage device 302 to see if it corresponds to a key exchange packet. In this way, overall content security is increased because unlimited secret keys can be utilized by the way of a key exchange/update scheme utilizing the extra control packets 222, 308. Furthermore, the decryption section 300 can still randomly access data of the storage device 302.

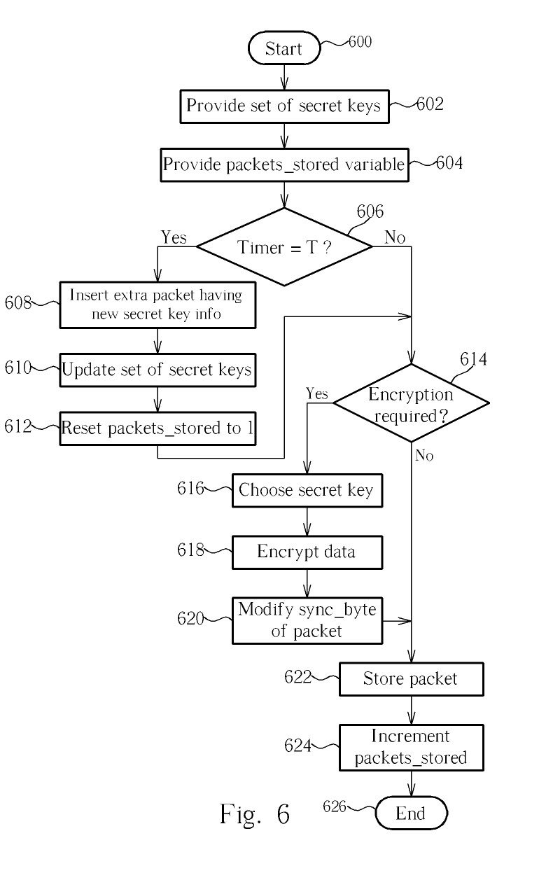

FIG. 6 shows a flowchart describing dynamic security operations in a PVR system according to an exemplary embodiment of the present invention. More specifically, FIG. 6 shows security operations when storing/recording a transport stream packet into the storage device 224 of FIG. 2. It should be noted that provided substantially the same result is achieved, the steps of the flowchart shown in FIG. 6 need not be in the exact order shown and need not be contiguous, that is, other steps can be intermediate. In this embodiment, the flowchart of FIG. 6 shows the operational steps when storing/recording a packet into the storage device 224 of FIG. 2 and contains the following steps:
Step 600: Start a packet storing operation for storing a packet containing data into the storage device 224.
Step 602: Provide a set of secret keys. The set of secret keys contains a predetermined number of secret keys used for encrypting data of packets to be stored in the storage device 224. These secret keys may be stored in a file meta-data database for the usage in decrypting the data of packets.
Step 604: Provide a packets -stored variable. The packets_stored variable represents the number of consecutive packets containing data stored in the storage device 224 and is used for tracking the number of packets stored in the PVR when generating meta-data storing the packet number of extra control packets 222.
Step 606: Has the interrupt signal I of the Timer 500 reached a predetermined time period T? If yes, proceed to step 610; otherwise, proceed to step 616.
Step 608: Insert an extra control packet 222 having information about the generation of new keys into the packet stream for storage into the storage device 224. In order to have smooth transaction between encryption, keys may be distinguished as even and odd (or set 1, 2, 3 or . . . ) and only change all even keys or odd keys.
Step 610: Update the set of secret keys in key table 216 by replacing old secret keys in the set of secret keys with the new secret keys corresponding to the key generation information used in step 608. Note, the number of secret keys in the set of secret keys in key table 216 remains the same.
Step 612: Reset the packets_stored variable to 1.
Step 614: Is encryption required? For example, does the PID of the packet to be stored indicate the packet contains data of protected content? If yes, proceed to step 616; otherwise, proceed to step 622.
Step 616: Choose a particular secret key from the set of secret keys. For example, the choice can involve a random function.
Step 618: Encrypt data of the packet to be stored using the particular secret key chosen in step 616.
Step 620: Modify the sync_byte of the packet to be stored to indicate the particular secret key used in step 618.
Step 622: Store the packet into the system memory and HD unit 228.
Step 624: Increment the packets -stored variable.
Step 626: Packet storage operations are complete. If another packet is to be stored, the system can return to step 606.

It should also be noted that the respective secret keys used in the above operations for encrypting (step 618) and decrypting keys are not necessarily the same secret key. For example, encryption and decryption will use same key for same packet; however, we can change the key every number of transport packets based on system design need. With embedded key in TS and packet insertion scheme it will able to change keys on the fly with less CPU or control logic interference.

The present invention provides a method of embedding information in a synchronization byte of a packet to be stored in a personal video recorder (PVR). The method allows dynamic security functions for improved content protection and comprises steps of providing a set of secret keys having a predetermined number of secret keys; generating a key indication value; selecting a secret key from the set of secret keys according to the key indication value to form a selected secret key; generating an encrypted packet based on the selected secret key and a packet in the transport stream by: encrypting the payload of the packet according to the selected secret key, and storing the key indication value in the sync field; and generating the protected transport stream based on the encrypted packet. In this way, random access of different packets in the PVR is possible because a decryption module can easily determine which secret key is used. That is, it can be determined which secret key should to be used to decrypt a stored packet by inspection of the modified synchronization byte. Additionally, by inserting an extra packet into the PVR every time period T, unlimited new security keys can be used by the PVR system according to the present invention. In contrast to the prior art, this method of providing a new secret key every predetermined number of packets is much faster than having to examine every packet stored in the PVR to see if the packet corresponds to a key exchange packet.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of processing a transport stream comprising a plurality of packets to output a protected transport stream, each packet comprising a packet header and a payload, the packet header comprising a sync field, the sync field carrying a preset sync pattern, the method comprising:
(a) providing a set of secret keys having a predetermined number of secret keys;
(b) generating a key indication value;
(c) selecting a secret key from the set of secret keys according to the key indication value to form a selected secret key;
(d) generating an encrypted packet based on the selected secret key and a packet in the transport stream by:
encrypting the payload of the packet according to the selected secret key, and storing the key indication value in the sync field; and
(e) generating the protected transport stream based on the encrypted packet.

2. The method of claim 1, wherein step (d) is performed on each packet in the transport stream to generate a plurality of encrypted packets and the protected transport stream is generated in accordance with the plurality of encrypted packets.

3. The method of claim 1, wherein step (d) is performed on a portion of packets in the transport stream to generate a plurality of encrypted packets and the protected transport stream is generated in accordance with the plurality of encrypted packets and the other portion of packets in the transport stream.

4. The method of claim 1, wherein the key indication value is stored in a dedicated portion of bits in the sync field.

5. The method of claim 4, wherein the dedicated portion of bits in the sync field corresponds to a plurality of bits having value of 0 in the sync field.

6. The method of claim 4, wherein the dedicated portion of bits in the sync field corresponds to a plurality of bits having value of 1 in the sync field.

7. The method of claim 4, wherein the dedicated portion of bits in the sync field is all the bits in the sync field.

8. The method of claim 1, wherein the structure of the transport stream complies with a Moving Pictures Expert Group (MPEG) MPEG-2 standard.

9. The method of claim 1, wherein the protected transport stream is written to a storage device.

10. The method of claim 9, wherein the protected transport stream is written to a hard disk.

11. The method of claim 1, further comprising:
(f) generating a plurality new secret key
(g) updating the set of secret keys by replacing a portion of the set of the secret keys with the new secret keys;
(h) generating at least one extra control packet to carry control information regarding the new secret keys and which portion of the set of the secret keys are replaced;
wherein the step (e) of generating the protected transport stream is based on the encrypted packet and the extra control packet.

12. A method of processing a protected transport stream comprising a plurality of packets to generate a decrypted transport stream, each packet comprising a packet header and a payload, the packet header comprising a sync field, the method comprising:
(a) providing a set of secret keys having a number of secret keys;
(b) identifying a packet of the protected transport stream as an encrypted packet or an unencrypted packet according to the sync field of the packet;
(c) extracting a key indication value from the sync field of the encrypted packet in the protected transport stream;
(d) selecting a secret key from the set of secret keys according to the extracted key indication value;
(e) generating a decrypted packet based on the encrypted packet and the selected secret key, comprising: decrypting the payload of the encrypted packet based on the selected secret key; and
(f) outputting the decrypted packet and the unencrypted packet, if available, to form the decrypted transport stream.

13. The method of claim 12, wherein the payload of the decrypted packet is obtained by decrypting the payload of the encrypted packet in the protected transport stream, and the sync field of the decrypted packet is set to a predetermined pattern.

14. The method of claim 12, wherein the packet of the protected transport stream substantially complies with MPEG-2 transport packet format.

15. The method of claim 12, wherein the decrypted packet substantially complies with MPEG-2 transport packet format.

16. The method of claim 12, wherein the decrypted transport stream comprises at least one embedded control packet having a specific PID and carrying control information for updating the set of the secret key, the method further comprising:
(g) identifying a packet in the decrypted transport stream as an embedded control packet; and
(h) updating the set of the secret key according to the embedded control packet.

17. An apparatus for processing a transport stream comprising a plurality of packets to output a protected transport stream, each packet comprising a packet header and a payload, the packet header comprising a sync field, the sync field carrying a preset sync pattern, the apparatus comprising:
a table storing a set of secret keys having a predetermined number of secret keys;
a key selecting module for generating a key indication value and selecting a secret key from the set of secret keys according to the key indication value to form a selected secret key;
an encryption module for receiving a packet in the transport stream and generating an encrypted packet by encrypting the payload of the clear packet according to the selected secret key to form the payload of the encrypted packet and storing the key indication value within the sync field of the encrypted packet;
wherein each encrypted packet is outputted to form the protected transport stream.

18. The apparatus of claim 17, wherein the encryption module processes each packet in the clear transport stream to generate a plurality of encrypted packets.

19. The apparatus of claim 17, further comprises:
a demux unit for receiving each packet in the transport stream to generate a plurality of first packets that is needed to be protected and a plurality of second packets that is not needed to be protected;
wherein the encryption module processes each first packet to generate a plurality of encrypted packets and each encrypted packets and each second packet are outputted to form the protected transport stream.

20. The apparatus of claim 17, wherein the key indication value is stored in a dedicated portion of bits in the sync field of the protected packet.

21. The apparatus of claim 20, wherein the dedicated portion of bits in the sync field of the encrypted packet corresponds to a plurality of bits having value of 0 in the sync field of the clear packet.

22. The apparatus of claim 20, wherein the dedicated portion of bits in the sync field of the encrypted packet corresponds to a plurality of bits having value of 1 in the sync field of the clear packet.

23. The apparatus of claim 20, wherein the dedicated portion of bits in the sync field of the encrypted packet is all the bits in the sync field.

24. The apparatus of claim 17, wherein the structure of the transport stream complies with a Moving Pictures Expert Group (MPEG) MPEG-2 standard.

25. The apparatus of claim 17, wherein the protected transport stream is written to a storage device.

26. The apparatus of claim 25, wherein the protected transport stream is written to a hard disk.

27. The apparatus of claim 25, further comprising:
a key table control unit, for generating a plurality new secret keys, updating the set of secret keys by replacing a portion of the set of the secret keys with the new secret keys, and generating at least one extra control packet to carry control information regarding the new secret keys and which portion of the set of the secret keys are replaced;
wherein the at least one extra control packet is further outputted to form the protected transport stream.

28. An apparatus for processing a protected transport stream comprising a plurality of packets to output a unprotected transport stream, each packet comprising a packet header and a payload, the packet header comprising a sync field, the apparatus comprising:
a key table storing a set of secret keys having a number of secret keys;
a demux unit for receiving the protected transport stream, identifying a packet of the protected transport stream as an encrypted packet or an unencrypted packet according to the sync field of the packet, outputting the encrypted packet to form an encrypted packet stream and outputting the unencrypted packet, if available, to form an unencrypted packet stream;
a key extraction module for outputting a selected secret key by extracting a key indication value from the sync field of an encrypted packet in the encrypted transport stream and using the key indication value to look into the key table to obtain the selected secret key;
a decryption module for receiving the encrypted packet, generating a decrypted packet based on the encrypted packet and the selected secret key by at least decrypting the payload of the encrypted packet according to the selected secret key, outputting each decrypted packet to form a decrypted packet stream; and
a mux unit for generating the unprotected packet stream by multiplexing the decrypted packet stream and the unencrypted packet stream, if available.

29. The apparatus of claim 28, wherein the payload of the decrypted packet is obtained by decrypting the payload of the encrypted packet, and the sync field in the decrypted packet is set to a predetermined pattern.

30. The apparatus of claim 28, wherein the encrypted packet substantially complies with MPEG-2 transport packet format.

31. The apparatus of claim 28, wherein the decrypted packet substantially complies with MPEG-2 transport packet format.

32. The apparatus of claim 28, wherein the unprotected transport stream comprises at least one embedded control packet having a specific PID and carrying control information for updating the set of the secret key, the apparatus further comprising:
a PID filter coupled to the mux unit, for extracting the at least one embedded control packet from the unprotected transport stream;
a key updating module coupled to the PID filter, for updating the set of the secret key according to the embedded control packet.
